(19) United States
(12) Patent Application Publication
(10) Pub. No.: US 2011/0256974 A1
(43) Pub. Date: Oct. 20, 2011

(54) VEHICULAR DRIVE UNIT TECHNICAL FIELD

(75) Inventor: Shigeru Okuwaki, SHizuoka-ken (JP)

(73) Assignee: Toyota Jidosha Kabushiki Kaisha, Aichi-ken (JP)

(21) Appl. No.: 13/000,662

(22) PCT Filed: Apr. 14, 2010
(86) PCT No.: PCT/JP2010/056707

§ 371 Date: Dec. 22, 2010

(51) Int. Cl. B60K 6/365; F16H 48/06

(52) U.S. Cl. 475/5; 180/65.21; 903/902

(57) ABSTRACT

A drive unit includes: an internal combustion engine; a first motor generator; an output portion which transmits power to driving wheels of a vehicle; a second motor generator; a first differential mechanism having a sun gear, a ring gear and a carrier; a second differential mechanism having a sun gear, a ring gear and a carrier; a connecting member which connects the sun gear and the ring gear with each other; and a brake capable of switching between a fixed state in which the sun gear and the ring gear are locked with respect to a case and a released state in which the locked state is released.

### TECHNICAL FIELD

The present invention relates to a vehicular drive unit including an internal combustion engine and a rotating electrical machine as drive sources.

### BACKGROUND ART

There is known a vehicular drive unit in which an internal combustion engine is connected to a carrier of a differential mechanism which is a planetary gear mechanism, a first motor generator is connected to a sun gear, an output shaft which transmits power to a driving wheel is connected to a ring gear, and a second motor generator is connected to the output shaft, and the vehicular drive unit includes a clutch which is interposed between the differential mechanism and the second motor generator to transmit power of the output shaft or interrupt the power transmission, and a brake which may switch between a fixing operation of the ring gear connected to the output shaft and a releasing operation of the ring gear (patent document 1). This vehicular drive unit may switch driving modes between a series hybrid mode in which entire power of the internal combustion engine is converted into electric power by the first motor generator by appropriately operating the clutch and the brake to drive the second motor generator, and a series parallel hybrid mode in which power of the internal combustion engine is split into two powers by the differential mechanism, one of the powers is converted into electric power by the first motor generator to drive the second motor generator, and the other power is transmitted to the output shaft.

### CITATION LIST

### Patent Literature

Patent Document 1: JP-A-2003-237392

### SUMMARY OF INVENTION

### Technical Problem

According to the vehicular drive unit of the patent document 1, since the output shaft and the second motor generator are coupled to each other at a constant gear ratio, a rotation speed ratio thereof is not changed before and after the driving mode is switched. Therefore, it is necessary to operate the second motor generator at a constant rotation speed ratio from a low speed region to a high speed region, and the maximum torque required for the second motor generator is increased. According to this, there is an adverse possibility that the second motor generator is increased in size.

Hence, it is an object of the present invention to provide a vehicular drive unit capable of preventing a second rotating electrical machine from increasing in size.

### Solution To Problem

A vehicular drive unit of the present invention includes: an internal combustion engine; a first rotating electrical machine; an output portion which transmits power to driving wheels of a vehicle; a second rotating electrical machine; a first differential mechanism which includes mutually differentially rotatable three rotating elements, the internal combustion engine being connected to a first rotating element which is one of the three rotating elements and the first rotating electrical machine being connected to a second rotating element which is another one of the three rotating elements; a second differential mechanism which includes mutually differentially rotatable three rotating elements, the output portion being connected to a first rotating element which is one of the three rotating elements and the second rotating electrical machine being connected to a second rotating element which is another one of the three rotating elements; a connecting member which connects a third rotating element which is a remaining one of the three rotating elements of the first differential mechanism and a third rotating element which is a remaining one of the three rotating elements of the second differential mechanism with each other such that the third rotating elements may integrally rotate; and an engaging device capable of switching between a fixed state in which the third rotating element of the first differential mechanism and the third rotating element of the second differential mechanism which are connected to each other are locked with respect to a fixing member and a released state in which the locked state is released.

According to this vehicular drive unit, the third rotating element of the first differential mechanism and the third rotating element of the second differential mechanism are connected to each other, and the locked state and the released state of these mutually connected rotating elements with respect to the fixing member are switched by the engaging device. Therefore, since they are switched to the fixed state by the engaging device and the third rotating element of the first differential mechanism is fixed, power of the internal combustion engine is transmitted to the first rotating electrical machine through the first differential mechanism and entirely converted into electric power. The second rotation mechanism is driven by the converted electric power, and a driving force of the second rotating electrical machine is output to the output portion through the second differential mechanism. That is, it is possible to realize the series hybrid mode by switching the state to the fixed state by the engaging device. On the other hand, power of the internal combustion engine is split into two powers by the first differential mechanism by switching the state to the released state by the engaging device, one of the powers is transmitted to the first rotating electrical machine, and the other power is transmitted to the second differential mechanism. The one power transmitted to the first rotating electrical machine is converted into electric power by the first rotating electrical machine, and the second rotating electrical machine is driven by the converted electric power. A driving force of the second rotating electrical machine and the other power transmitted to the second differential mechanism are merged and transmitted to the output portion. That is, the state is switched to the released state by the engaging device, and the series parallel hybrid mode may be realized.

In the case of the series hybrid mode, since the state is the fixed state, the third rotating element of the second differential mechanism is fixed. Therefore, a rotation speed ratio of the second rotating electrical machine and the output portion is fixed to a speed ratio which is determined by the second differential mechanism. If the fixed state is switched to the released state by the engaging device and the series hybrid mode is shifted to the series parallel hybrid mode, the third rotating element of the second differential mechanism may rotate at the same rotation speed as that of the third rotating element of the first differential mechanism. Therefore, by controlling the operations of the internal combustion engine and the first rotating electrical machine, the rotation speed ratio of the second rotating electrical machine and the output portion may be varied in a stepless manner. According to this, since it is possible to suppress the maximum torque required for the second rotating electrical machine by properly selecting the driving modes in accordance with a speed range, it is possible to prevent the second rotating electrical machine from increasing in size. In the present invention, the rotating electrical machine is a conception including any of a motor, a power generator, and a motor generator having function thereof.

In an aspect of the drive unit of the present invention, the second differential mechanism may be constituted such that the rotation speed of the second rotating electrical machine becomes higher than the rotation speed of the output portion when the fixed state is established by the engaging device. According to this aspect, since the rotation of the second rotating electrical machine is decelerated by the second differential mechanism, a driving force of the second rotating electrical machine may be amplified by the second differential mechanism. Thus, it is possible to further prevent the second rotating electrical machine from increasing in size.

In an aspect of the drive unit of the invention, a clutch may be provided, which is interposed between one of the first rotating element and the second rotating element of the first differential mechanism and one of the first rotating element and the second rotating element of the second differential mechanism, and which may switch between a connected state in which these rotating elements are integrally rotatably connected to each other and a released state in which the connected state is released. According to this aspect, if the clutch is brought into the connected state when the series parallel hybrid mode in which the state is switched to the released state by the engaging device is established, two of the rotating elements of the first differential mechanism and the second differential mechanism rotate at the same speed and therefore, an alignment chart of the first differential mechanism and an alignment chart of the second differential mechanism are superposed on one straight line. Thus, as compared with a case where the alignment charts are not superposed on one straight line, the number of subjects to be controlled is limited and therefore, there is an advantage that it becomes easy to control.

In an aspect of the drive unit of the invention, the first differential mechanism is constituted as a single pinion planetary gear mechanism including a sun gear, a ring gear and a carrier as three rotating elements, and the second differential mechanism is constituted as a single pinion planetary gear mechanism including a sun gear, a ring gear and a carrier as three rotating elements. The third rotating element of the first differential mechanism may be the sun gear and the third rotating element of the second differential mechanism may be the sun gear, or the third rotating element of the first differential mechanism may be the sun gear and the third rotating element of the second differential mechanism may be the ring gear, or the third rotating element of the first differential mechanism may be the ring gear and the third rotating element of the second differential mechanism may be the ring gear. According to this aspect, the rotating elements located at ends of the alignment charts of the first differential mechanism and the second differential mechanism rotate at the same speed. Therefore, since the first rotating electrical machine and the second rotating electrical machine rotate in the same direction when the series hybrid mode in which the engaging device is in the fixed state is established, it is possible to easily switch the series hybrid mode to the series parallel hybrid mode as compared with a case where the first rotating electrical machine and the second rotating electrical machine rotate in opposite directions from each other.

In this aspect, the third rotating element of the first differential mechanism may be the sun gear and the third rotating element of the second differential mechanism may be the sun gear, the engaging device may be disposed on a side opposite from the internal combustion engine across the first rotating electrical machine, the first differential mechanism, the second differential mechanism, the second rotating electrical machine and the output portion. In this case, since the engaging device is disposed on the side opposite from the internal combustion engine across above constituent elements, the outer diameter of the engaging device may be made smaller than a case where the engaging device is disposed on outer peripheries of the constituent elements. This configuration may reduce the drive unit in size in its radial direction.

In this aspect, the third rotating element of the first differential mechanism may be the sun gear and the third rotating element of the second differential mechanism may be the ring gear. In this case, since a distance from the third rotating element to the second rotating element in the alignment chart of the second differential mechanism is not long as compared with a case where other elements are connected to each other, it is possible to properly adjust the deceleration ratio of the second rotating electrical machine, and excessive rotation of the first rotating electrical machine may be suppressed.

### BRIEF DESCRIPTION OF DRAWINGS

FIG. 1 is a schematic skeleton diagram showing an entire configuration of a drive unit according to a first embodiment;

FIG. 2 is a diagram showing an operation engagement table of a brake and a clutch;

FIG. 3 is a diagram showing alignment charts of a first differential mechanism and a second differential mechanism according to the first embodiment;

FIG. 4 is a schematic skeleton diagram showing an entire configuration of a drive unit according to a second embodiment; FIG. 5 is a diagram showing alignment charts of a first differential mechanism and a second differential mechanism according to the second embodiment;

FIG. 6 is a schematic skeleton diagram showing an entire configuration of a drive unit according to a third embodiment;

FIG. 7 is a diagram showing alignment charts of a first differential mechanism and a second differential mechanism according to the third embodiment;

FIG. 8 is a schematic skeleton diagram showing an entire configuration of a drive unit according to a fourth embodiment;

FIG. 9 is a diagram showing alignment charts of a first differential mechanism and a second differential mechanism according to the fourth embodiment;

FIG. 10A is a diagram showing alignment charts according to a first modification of a V-coupling type;

FIG. 10B is a diagram showing alignment charts according to a second modification of the V-coupling type;

FIG. 10C is a diagram showing alignment charts according to a third modification of the V-coupling type;

FIG. 10D is a diagram showing alignment charts according to a fourth modification of the V-coupling type;

FIG. 10E is a diagram showing alignment charts according to a fifth modification of the V-coupling type;

FIG. 10F is a diagram showing alignment charts according to a sixth modification of the V-coupling type;

FIG. 11A is a diagram showing alignment charts according to a first modification of a T-coupling type;

FIG. 11B is a diagram showing alignment charts according to a second modification of the T-coupling type;

FIG. 11C is a diagram showing alignment charts according to a third modification of the T-coupling type;

FIG. 11D is a diagram showing alignment charts according to a fourth modification of the T-coupling type;

FIG. 11E is a diagram showing alignment charts according to a fifth modification of the T-coupling type;

FIG. 11F is a diagram showing alignment charts according to a sixth modification of the T-coupling type;

FIG. 11G is a diagram showing alignment charts according to a seventh modification of the T-coupling type;

FIG. 12A is a diagram showing alignment charts according to a first modification of an X-coupling type;

FIG. 12B is a diagram showing alignment charts according to a second modification of the X-coupling type;

FIG. 12C is a diagram showing alignment charts according to a third modification of the X-coupling type;

FIG. 12D is a diagram showing alignment charts according to a fourth modification of the X-coupling type;

FIG. 12E is a diagram showing alignment charts according to a fifth modification of the X-coupling type;

FIG. 12F is a diagram showing alignment charts according to a sixth modification of the X-coupling type;

FIG. 12G is a diagram showing alignment charts according to a seventh modification of an X-coupling type;

### DESCRIPTION OF EMBODIMENTS

### First Embodiment

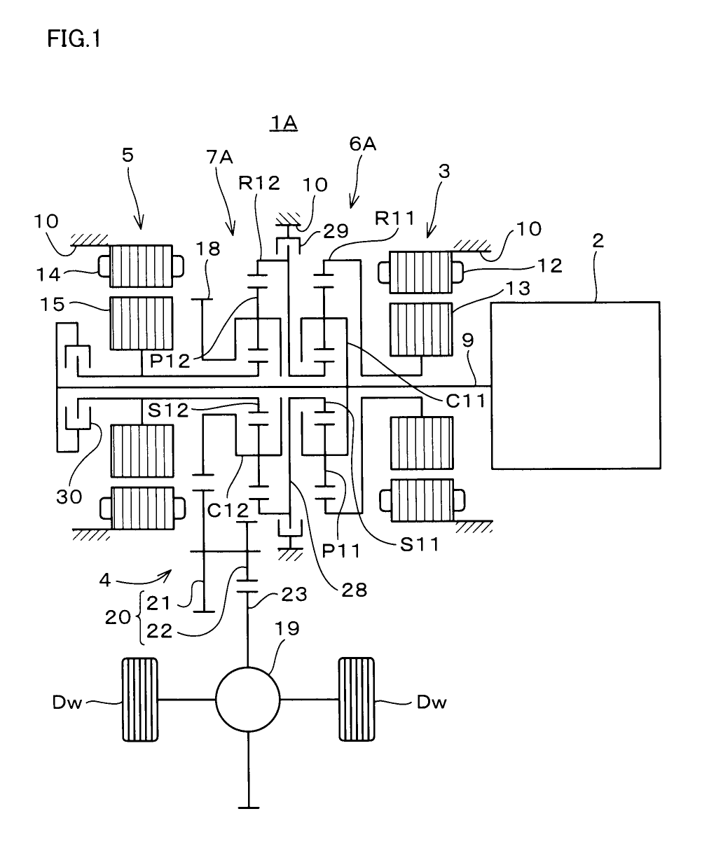

FIG. 1 is a schematic skeleton diagram showing an entire configuration of a drive unit according to a first embodiment of the present invention. The drive unit 1A is provided in a vehicle and used. The vehicle having the drive unit 1A functions as a hybrid vehicle including an internal combustion engine as a driving force source for running and a motor as a another driving force source for running. The drive unit 1A is suitable for being provided in a vehicle of FF layout in which driving wheels and a driving force source are located in a front portion of the vehicle.

The drive unit 1A includes an internal combustion engine 2, a first motor generator 3 as a first rotating electrical machine, an output portion 4 for transmitting power to driving wheels Dw of the vehicle, a second motor generator 5 as a second rotating electrical machine, a first differential mechanism 6A to which the internal combustion engine 2 and the first motor generator 3 are connected, and a second differential mechanism 7A to which the output portion 4 and the second motor generator 5 are connected.

The internal combustion engine 2 is constituted as a spark-ignition multicylinder internal combustion engine, and its power is transmitted to the first differential mechanism 6A through an input shaft 9. A damper (not shown) is interposed between the input shaft 9 and the internal combustion engine 2, and a torque variation of the internal combustion engine 2 is absorbed by the damper.

The first motor generator 3 and the second motor generator 5 have the same configurations, and include functions as motors and functions as power generators. The first motor generator 3 includes a stator 12 fixed to a case 10, and a rotor 13 coaxially disposed on the side of an inner periphery of the stator 12. Similarly, the second motor generator 5 also includes a stator 14 fixed to a case 10, and a rotor 15 coaxially disposed on the side of an inner periphery of the stator 14. The first motor generator 3 and the second motor generator 5 are electrically connected to each other through electric devices such as a buttery and an inverter (not shown).

To transmit power which is output from the second differential mechanism 7A to the driving wheels Dw, the output portion 4 includes an output gear 18 connected to the second differential mechanism 7A, a differential 19 which distributes the power to the left and right driving wheels Dw, and a gear train 20 which transmits the power of the output gear 18 to the differential 19. The gear train 20 includes a large-diameter gear 21 which meshes with the output gear 18, and a small-diameter gear 22 which is coaxial with the large-diameter gear 21 and which has the number of teeth smaller than that of the large-diameter gear 21. The small-diameter gear 22 meshes with a ring gear 23 provided on a case of the differential 19.

The first differential mechanism 6A is constituted as a single pinion planetary gear mechanism having three rotating elements which may mutually differentially rotate. The first differential mechanism 6A includes a sun gear S11 which is an external gear, a ring gear R11 which is an internal gear and which is disposed coaxially with the sun gear S11, and a carrier C11 which holds a pinion P11 meshing with these gears S11 and R11 such that the pinion P11 may rotate and revolve. In this embodiment, the internal combustion engine 2 is connected to the carrier C11 through the input shaft 9, and the first motor generator 3 is connected to the ring gear R11. Therefore, the carrier C11 corresponds to the first rotating element of the invention, the ring gear R11 corresponds to the second rotating element of the invention, and the sun gear S11 which is a remaining rotating element corresponds to the third rotating element.

The second differential mechanism 7A is constituted as a single pinion planetary gear mechanism having three rotating elements which may mutually differentially rotate. The second differential mechanism 7A includes a sun gear S12 which is an external gear, a ring gear R12 which is an internal gear disposed coaxially with the sun gear S12, and a carrier C12 which holds a pinion P12 meshing with these gears S12 and R12 such that the pinion P12 may rotate and revolve. In this embodiment, the output portion 4 is connected to the carrier C12, and the second motor generator 5 is connected to the sun gear S12. Therefore, the carrier C12 corresponds to the first rotating element, the sun gear S12 corresponds to the second rotating element of the invention, and the ring gear R12 which is a remaining rotating element corresponds to the third rotating element of the invention.

The drive unit 1A includes a connecting member 28 which connects the sun gear S11 of the first differential mechanism 6A and the ring gear R12 of the second differential mechanism 7A with each other such that they may integrally rotate, and a brake 29 as the engaging device which switches between a fixed state in which the sun gear S11 of the first differential mechanism 6A and the ring gear R12 of the second differential mechanism 7A are locked with respect to the case 10 which is the fixing member and a released state in which the locked state is released. The drive unit 1A includes a clutch 30 which is interposed between the carrier C11 of the first differential mechanism 6A and the sun gear S12 of the second differential mechanism 7A, and which switches between a connected state in which these elements are integrally rotatably connected to each other and a released state in which the connected state is released.

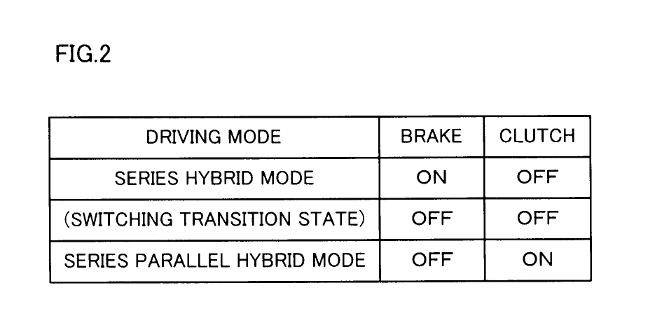

Driving modes of the drive unit 1A are switched between the series hybrid mode and the series parallel hybrid mode by operating the brake 29 and the clutch 30. These driving modes are realized by operating the brake 29 and the clutch 30 into states shown in the operation engagement table shown in FIG. 2. In FIG. 2, “ON” means that the operation states of the brake 29 and the clutch 30 are engagement states (operation states), and “OFF” means that the operation states of the brake 29 and the clutch 30 are released states (non-operation states).

As shown in FIG. 2, the series hybrid mode is realized if the brake 29 is turned ON and the clutch 30 is turned OFF. If the brake 29 is turned ON, the sun gear S11 of the first differential mechanism 6A is fixed. If the clutch 30 is turned OFF, power transmission from the carrier C11 of the first differential mechanism 6A to the sun gear S12 of the second differential mechanism 7A is interrupted. According to this, power of the internal combustion engine 2 is transmitted to the first motor generator 3 through the first differential mechanism 6A, and the power is entirely converted into electric power by the first motor generator 3. To be precisely, power of the internal combustion engine 2 from which various losses such as a meshing loss and a converting loss are subtracted is converted into electric power by the first motor generator 3. The second motor generator 5 is driven by the converted electric power, and its driving force is output to the output portion 4 through the second differential mechanism 7A. The series hybrid mode is realized in this manner.

On the other hand, the series parallel hybrid mode is realized when the brake 29 is turned OFF and the clutch 30 is turned ON. If the brake 29 is turned OFF, since the sun gear S11 of the first differential mechanism 6A and the ring gear R12 of the second differential mechanism 7A may integrally rotate, the power of the internal combustion engine 2 is split into two powers by the first differential mechanism 6A, one of the powers is transmitted to the first motor generator 3 and the other power is transmitted to the second differential mechanism 7A. The one power transmitted to the first motor generator 3 is converted into electric power by the first motor generator 3, and the second motor generator 5 is driven by the converted electric power. The driving force of the second motor generator 5 and the other power transmitted to the second differential mechanism 7A are merged by the second differential mechanism 7A, and the merged power is transmitted to the output portion 4. The series parallel hybrid mode is realized in this manner.

At the time of transition of the switching action between the driving modes, both the brake 29 and the clutch 30 are turned OFF. Therefore, when switching the series hybrid mode to the series parallel hybrid mode, the brake 29 is first operated from ON to OFF and the state is shifted to the transition state and then, the clutch 30 is operated from OFF to ON and the mode is shifted to the series parallel hybrid mode. On the other hand, when switching the series parallel hybrid mode to the series hybrid mode, the clutch 30 is first operated from ON to OFF and the state is shifted to the transition state and then, the brake 29 is operated from OFF to ON, and the mode is shifted to the series hybrid mode. In the case of the transition state, since a portion of power of the internal combustion engine 2 is not converted into electric power and is transmitted to the second differential mechanism 7A like the series parallel hybrid mode, it is also possible to utilize this state as the series parallel hybrid mode.

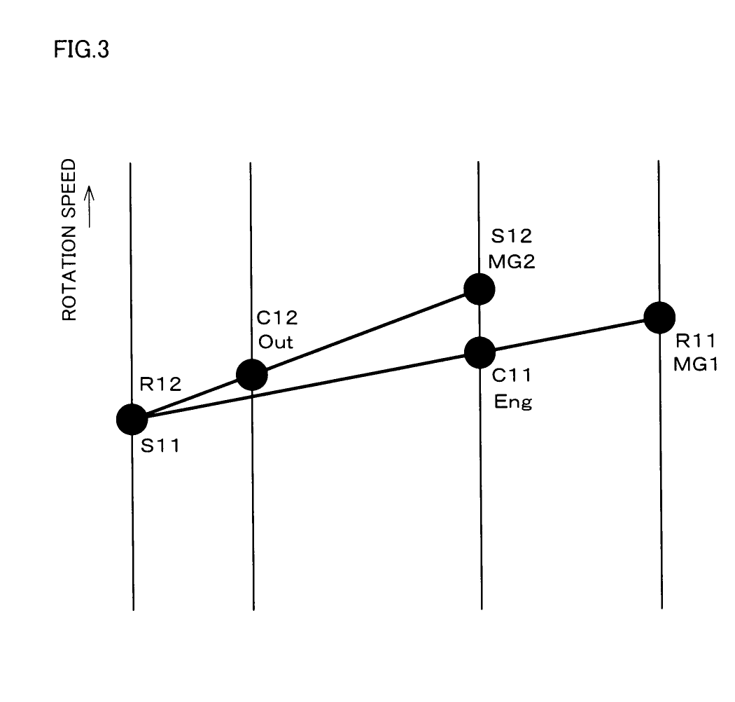

FIG. 3 shows alignment charts of the first differential mechanism 6A and the second differential mechanism 7A. In FIG. 3, “Eng” means the internal combustion engine 2, “MG1” means the first motor generator 3, “MG2” means the second motor generator 5, and “Out” means the output portion 4 (output gear 18). Meanings of the symbols shown in the alignment charts are as defined above unless otherwise specified. In the drive unit 1A, the sun gear S11 of the first differential mechanism 6A and the ring gear R12 of the second differential mechanism 7A are connected to each other. Therefore, as apparent from FIG. 3, the rotating elements located at the ends of the alignment charts rotate at the same speed. In the case of the series hybrid mode, since the sun gear S11 and the ring gear R12 are locked with respect to the case 10 by the brake 29, the rotation speeds thereof become 0. On the other hand, in the case of the series parallel hybrid mode, since the locked state of the sun gear S11 and the ring gear R12 is released and the clutch 30 is turned ON, the carrier C11 of the first differential mechanism 6A and the sun gear S12 of the second differential mechanism 7A are coupled to each other and the rotation speeds thereof become the same. Therefore, the alignment charts are superposed on one straight line. Thus, since the number of subjects to be controlled is limited as compared with a case where the alignment charts are not superposed on one straight line, there is a merit that it becomes easy to control.

As will be understood by referring to FIG. 3, in the case of the series hybrid mode, since the rotation speed of the ring gear R12 of the second differential mechanism 7A becomes 0, the rotation speed ratio of the second motor generator 5 and the output portion 4 (output gear 18) is fixed to a speed ratio determined by the second differential mechanism 7A. If the series hybrid mode is shifted to the series parallel hybrid mode, since the ring gear R12 of the second differential mechanism 7A may rotate at the same rotation speed as the sun gear S11 of the first differential mechanism 6A, it is possible to vary the rotation speed ratio of the second motor generator 5 and the output portion 4 in a stepless manner by controlling the operations of the internal combustion engine 2 and the first motor generator 3. According to this, since it is possible to suppress the maximum torque required for the second motor generator 5 by properly selecting the driving modes in accordance with a speed region, it is possible to prevent the second motor generator 5 from increasing in size.

In the series hybrid mode, the rotation speed of the second motor generator 5 becomes always higher than that of the output portion 4. That is, since the rotation of the second motor generator 5 is decelerated by the second differential mechanism 7A, the driving force of the second motor generator 5 may be amplified by the second differential mechanism 7A. Therefore, it is possible to further prevent the second motor generator 5 from increasing in size. Further, since the rotation speed of each of the sun gear S11 and the ring gear R12 located at the ends of the alignment charts becomes 0 at the time of the series hybrid mode, the first motor generator 3 and the second motor generator 5 rotate in the same direction. Therefore, it is possible to easily switch the series hybrid mode to the series parallel hybrid mode as compared with a case where the first motor generator 3 and the second motor generator 5 rotate in opposite directions. Further, since the sun gear S11 and the ring gear R12 are connected to each other, in the alignment chart of the second differential mechanism 7A, a distance between the ring gear R12 and the carrier C12 is shorter than that when other elements are connected. Therefore, this distance becomes shorter than 1 when a distance between the sun gear S12 and the carrier C12 is defined as 1 and therefore, it is possible to bring the deceleration ratio of the second motor generator 5 into an appropriately value, and excessive rotation of the first motor generator 3 may be suppressed.

### Second Embodiment

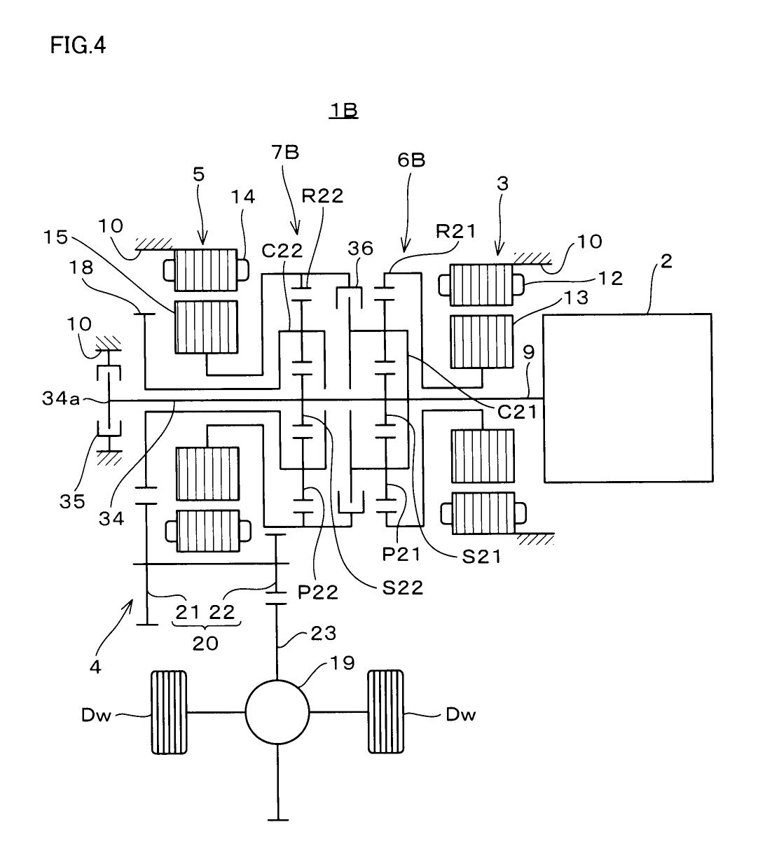

Next, a second embodiment of the invention will be described with reference to FIGS. 4 and 5. In the following description, configurations which are common to the first embodiment are designated with the same reference symbols, and description thereof will be omitted. FIG. 4 is a schematic skeleton diagram showing an entire configuration of a drive unit according to the second embodiment. The drive unit 1B includes a first differential mechanism 6B and a second differential mechanism 7B.

The first differential mechanism 6B is constituted as a single pinion planetary gear mechanism having three mutually differentially rotatable rotating elements. The first differential mechanism 6B includes a sun gear S21 which is an external gear, a ring gear R21 which is an internal gear and which is disposed coaxially with the sun gear S21, and a carrier C21 which holds a pinion P21 meshing with the gears S21 and R21 such that the pinion P21 may rotate and revolve. In this embodiment, the internal combustion engine 2 is connected to the carrier C21 through the input shaft 9, and the first motor generator 3 is connected to the ring gear R21. Therefore, the carrier C21 corresponds to the first rotating element of the invention, the ring gear R21 corresponds to the second rotating element of the invention, and the sun gear S21 which is a remaining rotating element corresponds to the third rotating element.

The second differential mechanism 7B is constituted as a single pinion planetary gear mechanism having three rotating elements which may mutually differentially rotate. The second differential mechanism 7B includes a sun gear S22 which is an external gear, a ring gear R22 which is an internal gear disposed coaxially with the sun gear S22, and a carrier C22 which holds a pinion P22 which meshes with the gears S22 and R22 such that the pinion P22 may rotate and revolve. In this embodiment, the output portion 4 is connected to the carrier C22, and the second motor generator 5 is connected to the ring gear R22. Therefore, the carrier C22 corresponds to the first rotating element, the ring gear R22 corresponds to the second rotating element of the invention, and the sun gear S22 which is a remaining rotating element corresponds to the third rotating element.

The drive unit 1B includes a connecting member 34 which connects the sun gear S21 of the first differential mechanism 6B and the sun gear S22 of the second differential mechanism 7B to each other such that these sun gears may integrally rotate. The connecting member 34 extends on an axis of the input shaft 9, and penetrates the second motor generator 5 and the output portion 4. A brake 35 as the engaging device is provided on an end 34a of the connecting member 34. The brake 35 may switch between a locked state of the connecting member 34 with respect to the case 10 and a released state thereof. That is, the brake 35 may switch between a fixed state in which the sun gear S21 of the first differential mechanism 6B and the sun gear 22 of the second differential mechanism 7B are locked with respect to the case 10, and a released state in which the locked state is released. As apparent from FIG. 4, the brake 35 is disposed on a side opposite from the internal combustion engine 2 across the first motor generator 3, the first differential mechanism 6B, the second differential mechanism 7B, the second motor generator 5 and the output portion 4. Therefore, an outer diameter of the brake 35 may be made small as compared with a case where the brake 35 is disposed on outer peripheries of the constituent elements like the brake 29 of the first embodiment shown in FIG. 1. According to this, the drive unit 1B may be made small in size in its radial direction.

The drive unit 1B includes a clutch 36 which is interposed between the carrier C21 of the first differential mechanism 6B and the ring gear 22 of the second differential mechanism 7B, and which switches between a connected state in which these elements are integrally rotatably connected to each other and a released state in which the connected state is released.

Like the first embodiment, the drive unit 1B may switch the driving modes between the series hybrid mode and the series parallel hybrid mode by operating the brake 35 and the clutch 36 into states shown in the operation engagement table shown in FIG. 2. FIG. 5 shows alignment charts of the first differential mechanism 6B and the second differential mechanism 7B.

As apparent from FIG. 5, the drive unit 1B shares similarity with the drive unit 1A of the first embodiment in that (1) the alignment charts are superposed on one straight line at the time of the series parallel hybrid mode, (2) a rotation speed ratio of the second motor generator 5 and the output portion 4 may be varied in a stepless manner at the time of series parallel hybrid mode, (3) rotation of the second motor generator 5 is always decelerated by the second differential mechanism 7B at the time of series hybrid mode, and (4) if rotation speeds of the sun gear S21 and the sun gear S22 located at ends of the alignment charts at the time of the series hybrid mode become 0, the first motor generator 3 and the second motor generator 5 rotate in the same direction. Concerning these common points, the same effects as those of the drive unit 1A may be obtained.

### Third Embodiment

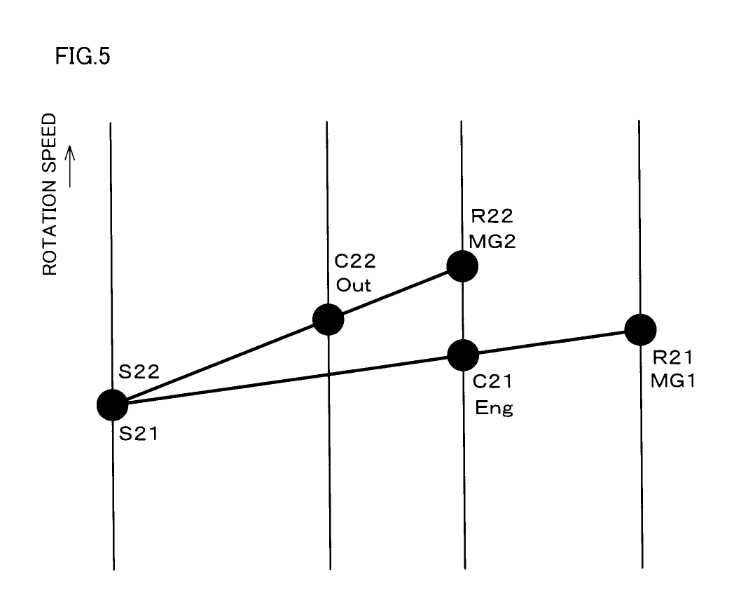

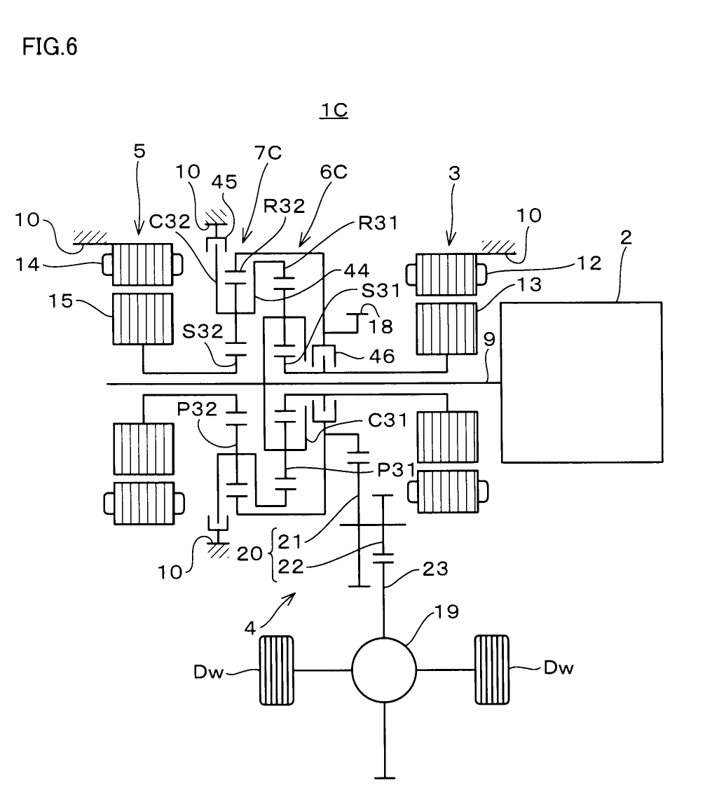

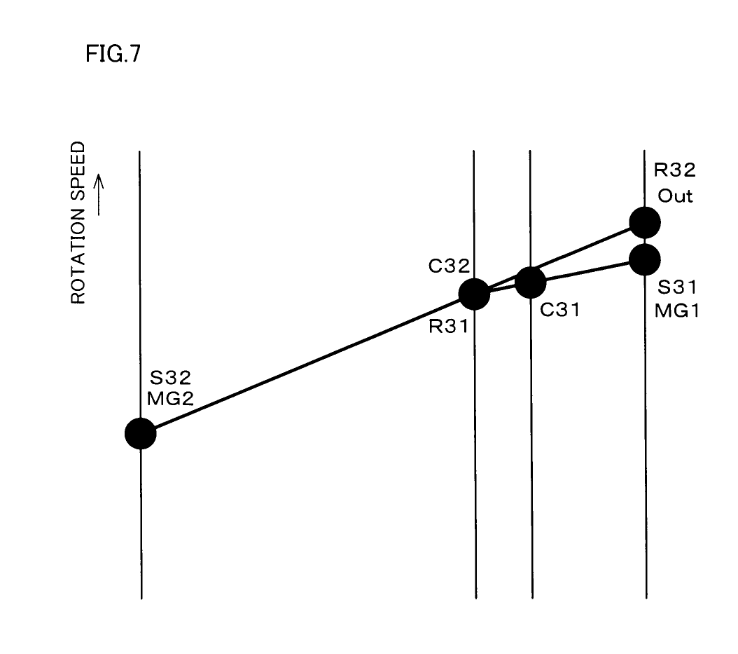

Next, a third embodiment of the invention will be described with reference to FIGS. 6 and 7. In the following description, configurations which are common to the first embodiment are designated with the same reference symbols, and description thereof will be omitted. FIG. 6 is a schematic skeleton diagram showing an entire configuration of a drive unit according to the third embodiment. The drive unit 1C includes a first differential mechanism 6C and a second differential mechanism 7C.

The first differential mechanism 6C is constituted as a single pinion planetary gear mechanism having three rotating elements which may mutually differentially rotate. The first differential mechanism 6C includes a sun gear S31 which is an external gear, a ring gear R31 which is an internal gear disposed coaxially with the sun gear S31, and a carrier C31 which holds a pinion P31 meshing with the gears S31 and R31 such that the pinion P31 may rotate and revolve. In this embodiment, the internal combustion engine 2 is connected to the carrier C31 through the input shaft 9, and the first motor generator 3 is connected to the sun gear S31. Therefore, the carrier C31 corresponds to the first rotating element, the sun gear S31 corresponds to the second rotating element of the invention, and the ring gear R31 which is a remaining rotating element corresponds to the third rotating element of the invention.

The second differential mechanism 7C is constituted as a single pinion planetary gear mechanism having three rotating elements which may differentially rotate. The second differential mechanism 7C includes a sun gear S32 which is an external gear, a ring gear R32 which is an internal gear disposed coaxially with the sun gear S32, and a carrier C32 which holds a pinion P32 meshing with the gears S32 and R32 such that the pinion P32 may rotate and revolve. In this embodiment, the output portion 4 is connected to the ring gear R32, and the second motor generator 5 is connected to the sun gear S32. Therefore, the ring gear R32 corresponds to the first rotating element, the sun gear S32 corresponds to the second rotating element of the invention, and the carrier C32 which is a remaining rotating element corresponds to the third rotating element of the invention.

The drive unit 1C includes a connecting member 44 which connects the ring gear R31 of the first differential mechanism 6C and the carrier C32 of the second differential mechanism 7C with each other such that they may integrally rotate, a brake 45 which may switch between a fixed state in which the ring gear R31 of the first differential mechanism 6C and the carrier C32 of the second differential mechanism 7C are locked with respect to the case 10 and a released state in which the locked state is released, and a clutch 46 which is interposed between the sun gear S31 of the first differential mechanism 6C and the ring gear R32 of the second differential mechanism 7C, and which switches between a connected state in which these elements are integrally rotatably connected to each other, and a released state in which the connected state is released.

Like the first and second embodiments, the drive unit 1C may switch the driving modes between the series hybrid mode and the series parallel hybrid mode by operating the brake 45 and the clutch 46 into states shown in the operation engagement table shown in FIG. 2. FIG. 7 shows alignment charts of the first differential mechanism 6C and the second differential mechanism 7C. As apparent from FIG. 7, the drive unit 10 shares similarity with the drive unit 1A of the first embodiment in that (1) the alignment charts are superposed on one straight line at the time of the series parallel hybrid mode, (2) a rotation speed ratio of the second motor generator 5 and the output portion 4 may be varied in a stepless manner at the time of series parallel hybrid mode, and (3) rotation of the second motor generator 5 is always decelerated by the second differential mechanism 7C at the time of series hybrid mode. Concerning these common points, the same effects as those of the drive unit 1A may be obtained.

### Fourth Embodiment

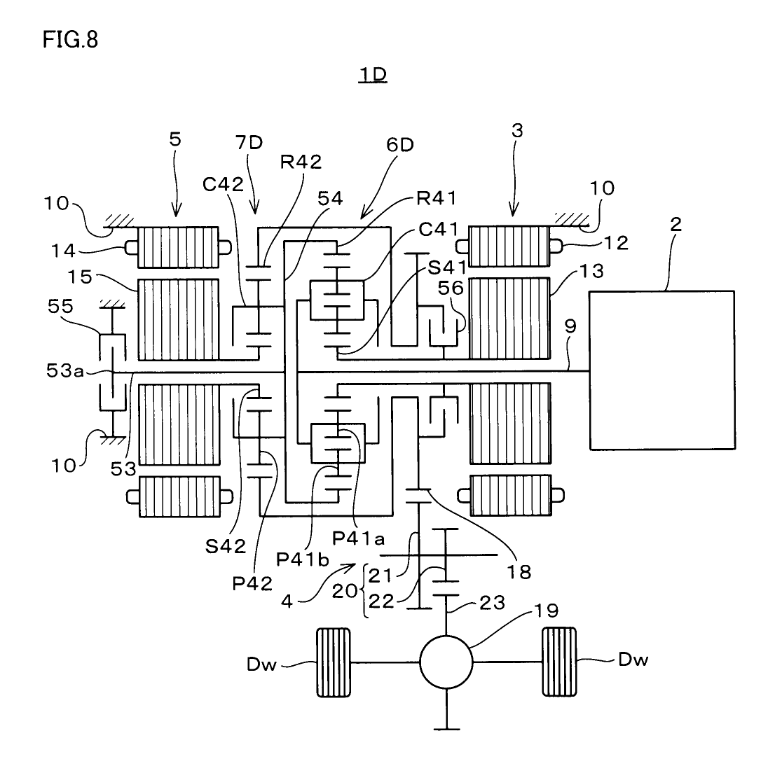

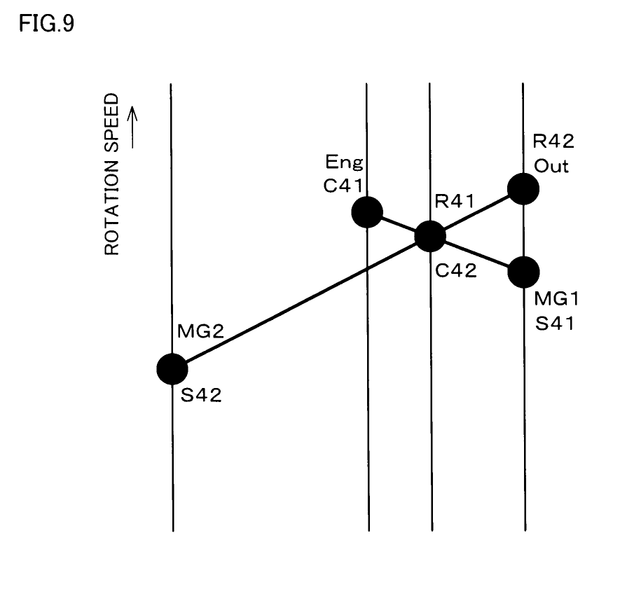

Next, a fourth embodiment of the invention will be described with reference to FIGS. 8 and 9. In the following description, configurations which are common to the first embodiment are designated with the same reference symbols, and description thereof will be omitted. FIG. 8 is a schematic skeleton diagram showing an entire configuration of a drive unit according to the fourth embodiment. The drive unit 1D includes a first differential mechanism 6D and a second differential mechanism 7D.

The first differential mechanism 6D is constituted as a double pinion planetary gear mechanism having three rotating elements which may mutually differentially rotate. The first differential mechanism 6D includes a sun gear S41 which is an external gear, a ring gear R41 which is an internal gear disposed coaxially with the sun gear S41, and a carrier C41 which holds a first pinion P41a meshing with the sun gear S41 and a second pinion P41b which meshes with the ring gear R41 such that these pinions may rotate and revolve in a state in which the pinions mesh with each other. In this embodiment, the internal combustion engine 2 is connected to the carrier C41 through the input shaft 9, and the first motor generator 3 is connected to the sun gear S41. Therefore, the carrier C41 corresponds to the first rotating element, the sun gear S41 corresponds to the second rotating element of the invention, and the ring gear R41 which is a remaining rotating element corresponds to the third rotating element.

The second differential mechanism 7D is constituted as a single pinion planetary gear mechanism having three rotating elements which may mutually differentially rotate. The second differential mechanism 7D includes a sun gear S42 which is an external gear, a ring gear R42 which is an internal gear disposed coaxially with the sun gear S42, and a carrier C42 which holds a pinion P42 meshing with the gears S42 and R42 such that the pinion P42 may rotate and revolve. In this embodiment, the output portion 4 is connected to the ring gear R42, and the second motor generator 5 is connected to the sun gear S42. Therefore, the ring gear R42 corresponds to the first rotating element, the sun gear S42 corresponds to the second rotating element of the invention, and the carrier C42 which is a remaining rotating element corresponds to the third rotating element.

The drive unit 1D includes a connecting member 54 which connects the ring gear R41 of the first differential mechanism 6D and the carrier C42 of the second differential mechanism 7D with each other such that the ring gear R41 and the carrier C42 may integrally rotate. An extending member 53 which extends on an axis of the input shaft 9 and penetrates the second motor generator 5 is coupled to the carrier C42 of the second differential mechanism 7D. A brake 55 as the engaging device is provided on an end 53a of the extending member 53. The brake 55 may switch between a locked state of the extending member 53 with respect to the case 10 and a released state thereof. That is, the brake 55 may switch between a fixed state in which the ring gear R41 of the first differential mechanism 6D and the carrier C42 of the second differential mechanism 7D are locked with respect to the case 10 and a released state in which the locked state is released. As apparent from FIG. 8, the brake 55 is disposed on a side opposite from the internal combustion engine 2 across the first motor generator 3, the first differential mechanism 6D, the second differential mechanism 7D, the second motor generator 5, and the output portion 4. Like the second embodiment, since an outer diameter of the brake 55 may be made small, the drive unit 1D may be reduced in size in its radial direction.

The drive unit 1D includes a clutch 56 which is interposed between the sun gear S41 of the first differential mechanism 6D and the ring gear R42 of the second differential mechanism 7D, and which switches between a connected state in which these elements are integrally rotatably connected to each other, and a released state in which the connected state is released.

Like the first and second embodiments, the drive unit 1D may switch the driving modes between the series hybrid mode and the series parallel hybrid mode by operating the brake 55 and the clutch 56 into states shown in the operation engagement table shown in FIG. 2. FIG. 9 shows alignment charts of the first differential mechanism 6C and the second differential mechanism 7C. As apparent from FIG. 9, the drive unit 1D shares similarity with the drive unit 1A of the first embodiment in that (1) the alignment charts are superposed on one straight line at the time of the series parallel hybrid mode, (2) a rotation speed ratio of the second motor generator 5 and the output portion 4 may be varied in a stepless manner at the time of series parallel hybrid mode, and (3) rotation of the second motor generator 5 is always decelerated by the second differential mechanism 7D at the time of series hybrid mode. Concerning these common points, the same effects as those of the drive unit 1A may be obtained. Further, since it is easy to constitute the differential mechanisms 6D and 7D such that the deceleration ratios of the internal combustion engine 2 and the second motor generator 5 in the driving modes and the mechanical point become appropriate ratios, the drive unit 1D has high practicality. The mechanical point means an operational state in which a rotation speed of the first motor generator 3 when the brake 55 and the clutch 56 are turned OFF becomes 0.

### Modification

The present invention is not limited to the embodiments, and the invention may be carried out in various modes within a range of the subject matter of the invention. The connection modes between the rotating elements of the first and second differential mechanisms, the internal combustion engine and the output portion, and the connection modes between the first and second differential mechanism are not limited to those of the embodiments, and many variations of the connection modes exist. In the first and second embodiments, since the rotating elements located at the ends of the alignment charts are connected to each other as shown in FIGS. 3 and 5, the two alignment charts are coupled to each other in a V-shape. Hence, this connection mode is called a V-shaped coupled type. In the third embodiment, since the rotating element located at the central portion of one of the alignment charts and the rotating element located at the end of the other alignment chart are connected to each other as shown in FIG. 7, the two alignment charts are coupled to each other in a T-shape. Hence, this connection mode is called a T-shaped coupled type. In the fourth embodiment, since the rotating elements located at the central portions of the alignment charts are coupled to each other as shown in FIG. 9, the two alignment charts are coupled in an X-shape. Hence, this connection mode is called an X-shaped coupled type.

Many modifications of connection modes between the first differential mechanism and the second differential mechanism will be described in categories of the V-coupled type, T-coupled type and X-coupled type. To simplify the description, the modifications will be described using only alignment charts. In each of the drawings, a numerical subscript “1” means the rotating elements of the first differential mechanism, and a numerical subscript “2” means the rotating elements of the second differential mechanism.

### V-Coupled Type

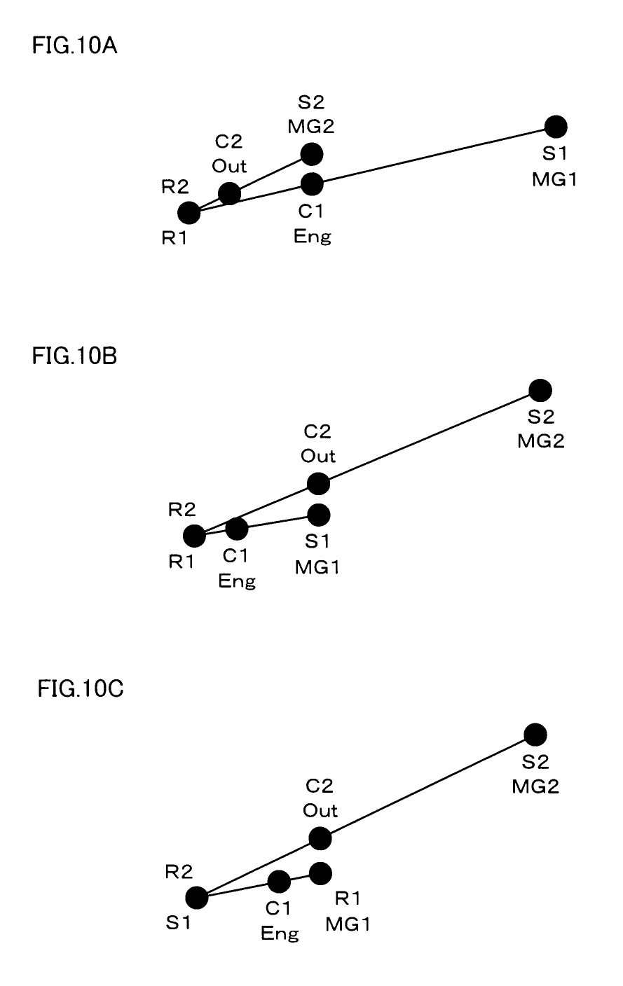

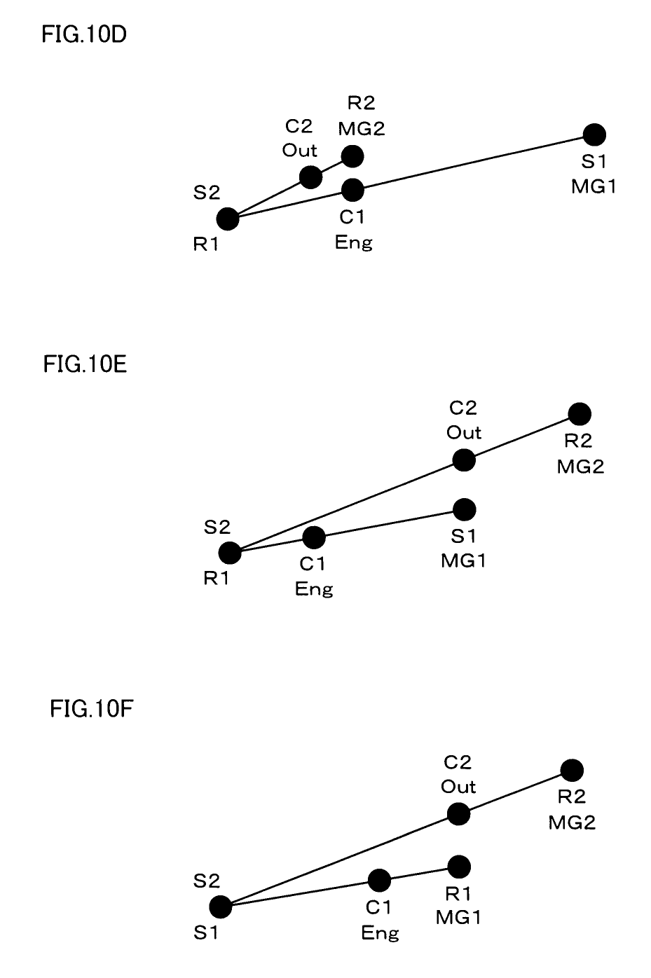

FIGS. 10A to 10F show alignment charts of the modifications of the V-coupled type. FIG. 10A shows the alignment chart according to a first modification of the V-coupled type. According to the first modification, a ring gear R1 of a first differential mechanism and a ring gear R2 of a second differential mechanism are connected to each other, a brake which is the engaging device is provided on these rotating elements, and a clutch is provided between a carrier C1 of the first differential mechanism and a sun gear S2 of the second differential mechanism. In the first modification, the alignment chart of the second differential mechanism is shorter than the alignment chart of the first differential mechanism.

In the first modification, the first differential mechanism includes the carrier C1 as the first rotating element, a sun gear S1 as the second rotating element, and the ring gear R1 as the third rotating element. The second differential mechanism includes a carrier C2 as the first rotating element, the sun gear S2 as the second rotating element, and the ring gear R2 as the third rotating element.

FIG. 10B shows alignment charts according to a second modification of the V-coupled type. In the second modification, a ring gear R1 of a first differential mechanism and a ring gear R2 of a second differential mechanism are connected to each other, a brake which is the engaging device is provided on these rotating elements, and a clutch is provided between a sun gear S1 of the first differential mechanism and a carrier C2 of the second differential mechanism. In the second modification, the alignment chart of the second differential mechanism of the output system is longer than the alignment chart of the first differential mechanism. In the second modification, the first differential mechanism includes a carrier C1 as the first rotating element, the sun gear S1 as the second rotating element, and the ring gear R1 as the third rotating element. The second differential mechanism includes the carrier C2 as the first rotating element, a sun gear S2 as the second rotating element and the ring gear R2 as the third rotating element.

FIG. 10B shows alignment charts according to a third modification of the V-coupled type. In the third modification, a sun gear S1 of a first differential mechanism and a ring gear R2 of a second differential mechanism are connected to each other, a brakes which is the engaging device is provided on these rotating elements, and a clutch is provided between a ring gear R1 of the first differential mechanism and a carrier C2 of the second differential mechanism. In the third modification, the alignment chart of the second differential mechanism of the output system is longer than the alignment chart of the first differential mechanism. In the third modification, the first differential mechanism includes a carrier C1 as the first rotating element, the ring gear R1 as the second rotating element, and the sun gear S1 as the third rotating element. The second differential mechanism includes the carrier C2 as the first rotating element, a sun gear S2 as the second rotating element and the ring gear R2 as the third rotating element.

FIG. 10D shows alignment charts according to a fourth modification of the V-coupled type. In the fourth modification, a ring gear R1 of a first differential mechanism and a sun gear S2 of a second differential mechanism are connected to each other, a brake which is the engaging device is provided on these rotating elements, and a clutch is provided between a carrier C1 of the first differential mechanism and a ring gear R2 of the second differential mechanism. In the fourth modification, the alignment chart of the second differential mechanism of the output system is shorter than the alignment chart of the first differential mechanism. In the fourth modification, the first differential mechanism includes the carrier C1 as the first rotating element, a sun gear S1 as the second rotating element, and the ring gear R1 as the third rotating element. The second differential mechanism includes a carrier C2 as the first rotating element, the ring gear R2 as the second rotating element and the sun gear S2 as the third rotating element.

FIG. 10E shows alignment charts according to a fifth modification of the V-coupled type. In the fifth modification, a ring gear R1 of a first differential mechanism and a sun gear S2 of a second differential mechanism are connected to each other, a brake which is the engaging device is provided on these rotating elements, and a clutch is provided between a sun gear S1 of the first differential mechanism and a carrier C2 of the second differential mechanism. In the fifth modification, the alignment chart of the second differential mechanism of the output system is longer than the alignment chart of the first differential mechanism. In the fifth modification, the first differential mechanism includes a carrier C1 as the first rotating element, the sun gear S1 as the second rotating element, and the ring gear R1 as the third rotating element. The second differential mechanism includes the carrier C2 as the first rotating element, a ring gear R2 as the second rotating element and the sun gear S2 as the third rotating element.

FIG. 10F shows alignment charts according to a sixth modification of the V-coupled type. In the sixth modification, a sun gear S1 of a first differential mechanism and a sun gear S2 of a second differential mechanism are connected to each other, a brake which is the engaging device is provided on these rotating elements, and a clutch is provided between a ring gear R1 of the first differential mechanism and a carrier C2 of the second differential mechanism. In the sixth modification, the alignment chart of the second differential mechanism of the output system is longer than the alignment chart of the first differential mechanism. In the sixth modification, the first differential mechanism includes a carrier C1 as the first rotating element, the ring gear R1 as the second rotating element, and the sun gear S1 as the third rotating element. The second differential mechanism includes the carrier C2 as the first rotating element, a ring gear R2 as the second rotating element and the sun gear S2 as the third rotating element.

The modifications of the V-coupled type shown in FIGS. 10A to 10F shares similarity with the first and second embodiments in that (1) the alignment charts are superposed on one straight line at the time of the series parallel hybrid mode, (2) a rotation speed ratio of the second motor generator 5 and the output portion 4 may be varied in a stepless manner at the time of series parallel hybrid mode, (3) rotation of the second motor generator 5 is always decelerated by the second differential mechanism at the time of series hybrid mode, and (4) rotation speeds of the rotating elements becoming 0, which is located at ends of the alignment charts at the time of the series hybrid mode, the first motor generator 3 and the second motor generator 5 rotate in the same direction. Concerning these common points, the same effects as those of the first and second embodiments may be obtained.

### T-Coupled Type

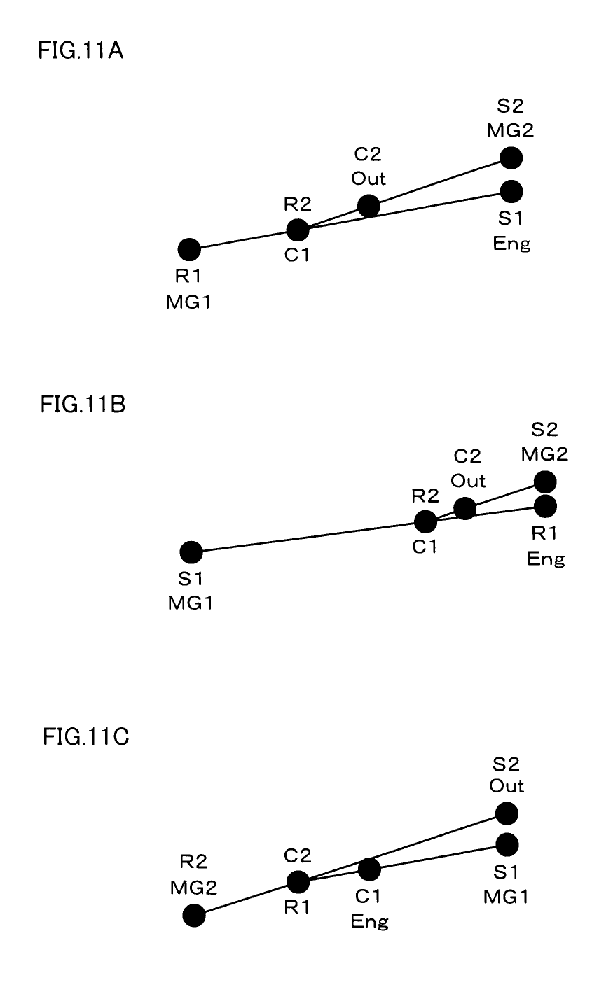

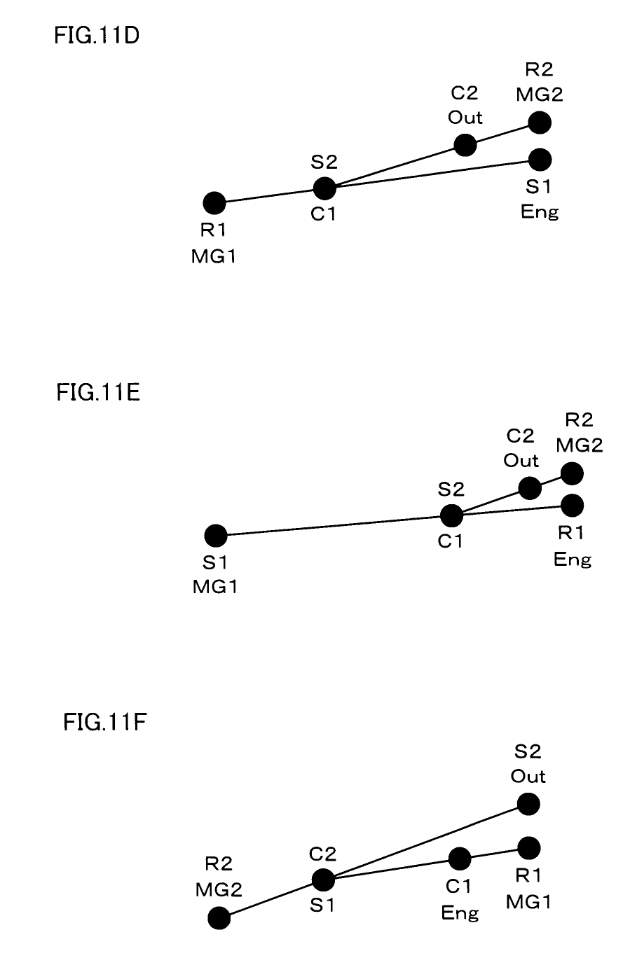

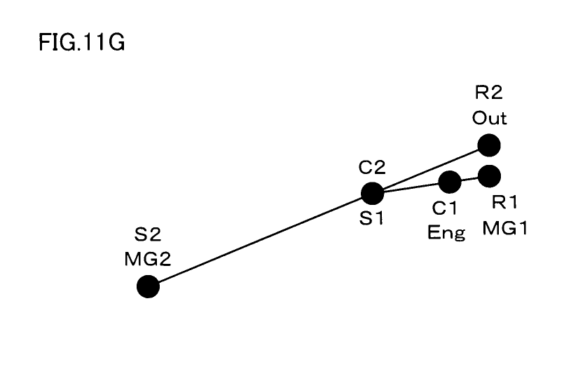

FIGS. 11A to 11G show alignment charts of the modifications of the T-coupled type. FIG. 11A shows the alignment chart according to a first modification of the T-coupled type. According to the first modification, a carrier C1 of a first differential mechanism and a ring gear R2 of a second differential mechanism are connected to each other, a brake which is the engaging device is provided on these rotating elements, and a clutch is provided between a sun gear S1 of the first differential mechanism and a sun gear S2 of the second differential mechanism. In the first modification, the alignment chart of the second differential mechanism is shorter than the alignment chart of the first differential mechanism. In the first modification, the first differential mechanism includes the sun gear S1 as the first rotating element, a ring gear R1 as the second rotating element, and the carrier C1 as the third rotating element. The second differential mechanism includes a carrier C2 as the first rotating element, the sun gear S2 as the second rotating element, and the ring gear R2 as the third rotating element.

FIG. 11B shows alignment charts according to a second modification of the T-coupled type. In the second modification, a carrier C1 of a first differential mechanism and a ring gear R2 of a second differential mechanism are connected to each other, a brake which is the engaging device is provided on these rotating elements, and a clutch is provided between a ring gear R1 of the first differential mechanism and a sun gear S2 of the second differential mechanism. In the second modification, the alignment chart of the second differential mechanism of the output system is shorter than the alignment chart of the first differential mechanism. In the second modification, the first differential mechanism includes the ring gear R1 as the first rotating element, a sun gear S1 as the second rotating element, and the carrier C1 as the third rotating element. The second differential mechanism includes a carrier C2 as the first rotating element, the sun gear S2 as the second rotating element and the ring gear R2 as the third rotating element.

FIG. 11C shows alignment charts according to a third modification of the T-coupled type. In the third modification, a ring gear R1 of a first differential mechanism and a carrier C2 of a second differential mechanism are connected to each other, a brake which is the engaging device is provided on these rotating elements, and a clutch is provided between a sun gear S1 of the first differential mechanism and a sun gear S2 of the second differential mechanism. In the third modification, the alignment chart of the second differential mechanism of the output system is longer than the alignment chart of the first differential mechanism. In the third modification, the first differential mechanism includes a carrier C1 as the first rotating element, the sun gear S1 as the second rotating element, and the ring gear R1 as the third rotating element. The second differential mechanism includes the sun gear S2 as the first rotating element, a ring gear R2 as the second rotating element and the carrier C2 as the third rotating element.

FIG. 11D shows alignment charts according to a fourth modification of the T-coupled type. In the fourth modification, a carrier C1 of a first differential mechanism and a sun gear S2 of a second differential mechanism are connected to each other, a brake which is the engaging device is provided on these rotating elements, and a clutch is provided between a sun gear S1 of the first differential mechanism and a ring gear R2 of the second differential mechanism. In the fourth modification, the alignment chart of the second differential mechanism of the output system is shorter than the alignment chart of the first differential mechanism. In the fourth modification, the first differential mechanism includes the sun gear S1 as the first rotating element, a ring gear R1 as the second rotating element, and the carrier C1 as the third rotating element. The second differential mechanism includes a carrier C2 as the first rotating element, the ring gear R2 as the second rotating element and the sun gear S2 as the third rotating element.

FIG. 11E shows alignment charts according to a fifth modification of the T-coupled type. In the fifth modification, a carrier C1 of a first differential mechanism and a sun gear S2 of a second differential mechanism are connected to each other, a brake which is the engaging device is provided on these rotating elements, and a clutch is provided between a ring gear R1 of the first differential mechanism and a ring gear R2 of the second differential mechanism. In the fifth modification, the alignment chart of the second differential mechanism of the output system is shorter than the alignment chart of the first differential mechanism. In the fifth modification, the first differential mechanism includes the ring gear R1 as the first rotating element, a sun gear S1 as the second rotating element, and the carrier C1 as the third rotating element. The second differential mechanism includes a carrier C2 as the first rotating element, the ring gear R2 as the second rotating element and the sun gear S2 as the third rotating element.

FIG. 11F shows alignment charts according to a sixth modification of the T-coupled type. In the sixth modification, a sun gear S1 of a first differential mechanism and a carrier C2 of a second differential mechanism are connected to each other, a brake which is the engaging device is provided on these rotating elements, and a clutch is provided between a ring gear R1 of the first differential mechanism and a sun gear S2 of the second differential mechanism. In the sixth modification, the alignment chart of the second differential mechanism of the output system is longer than the alignment chart of the first differential mechanism. In the sixth modification, the first differential mechanism includes a carrier C1 as the first rotating element, the ring gear R1 as the second rotating element, and the sun gear S1 as the third rotating element. The second differential mechanism includes the sun gear S2 as the first rotating element, a ring gear R2 as the second rotating element and the carrier C2 as the third rotating element.

FIG. 11G shows alignment charts according to a seventh modification of the T-coupled type. In the seventh modification, a sun gear S1 of a first differential mechanism and a carrier C2 of a second differential mechanism are connected to each other, a brake which is the engaging device is provided on these rotating elements, and a clutch is provided between a ring gear R1 of the first differential mechanism and a ring gear R2 of the second differential mechanism. In the seventh modification, the alignment chart of the second differential mechanism of the output system is longer than the alignment chart of the first differential mechanism. In the seventh modification, the first differential mechanism includes a carrier C1 as the first rotating element, the ring gear R1 as the second rotating element, and the sun gear S1 as the third rotating element. The second differential mechanism includes the ring gear R2 as the first rotating element, a sun gear S2 as the second rotating element and the carrier C2 as the third rotating element.

The modifications of the V-coupled type shown in FIGS. 11A to 11G shares similarity with the third embodiment in that (1) the alignment charts are superposed on one straight line at the time of the series parallel hybrid mode, and (2) a rotation speed ratio of the second motor generator 5 and the output portion 4 may be varied in a stepless manner at the time of series parallel hybrid mode. Concerning these common points, the same effects as those of the third embodiment may be obtained.

### X-Coupled Type

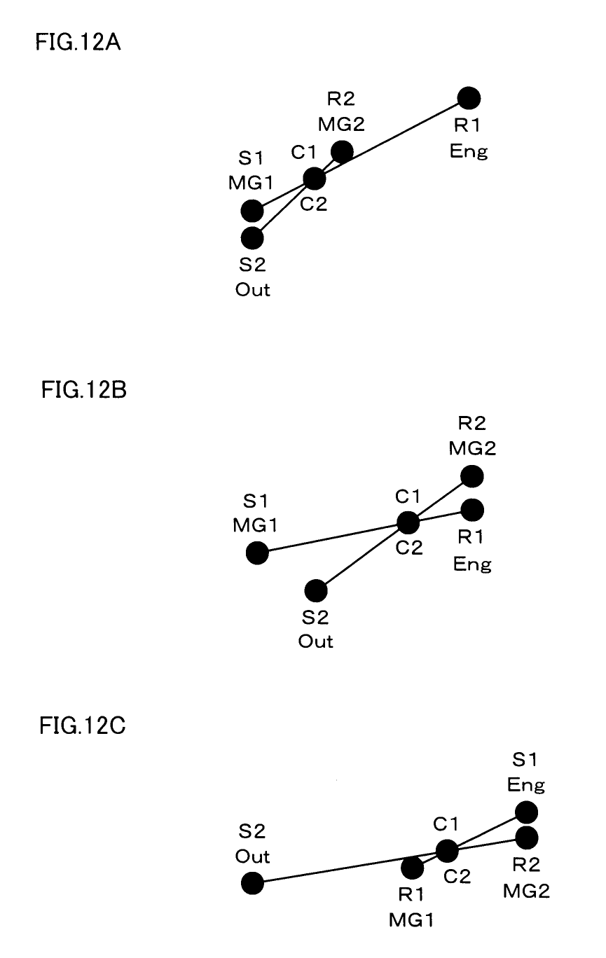

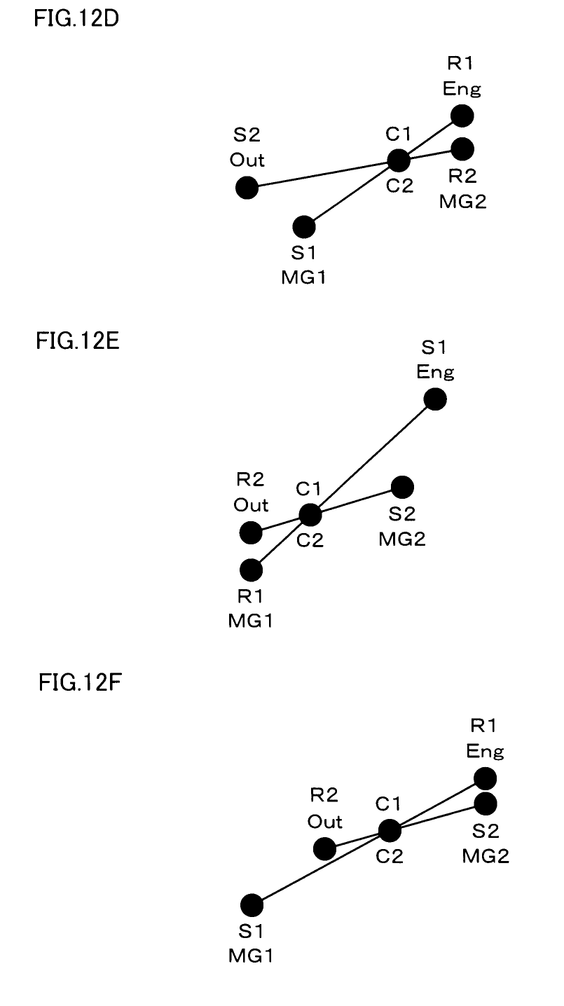

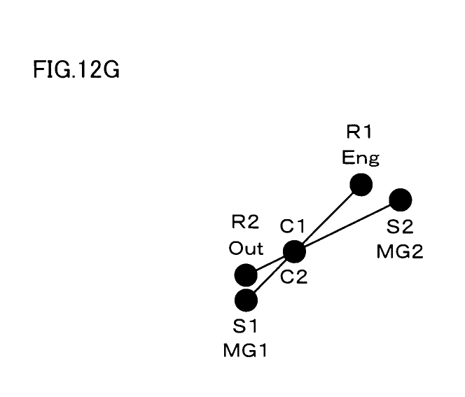

FIGS. 12A to 12G show alignment charts of the modifications of the X-coupled type. FIG. 12A shows the alignment chart according to a first modification of the X-coupled type. According to the first modification, a carrier C1 of a first differential mechanism and a carrier C2 of a second differential mechanism are connected to each other, a brake which is the engaging device is provided on these rotating elements, and a clutch is provided between a sun gear S1 of the first differential mechanism and a sun gear S2 of the second differential mechanism. In the first modification, the alignment chart of the second differential mechanism is shorter than the alignment chart of the first differential mechanism. In the first modification, the first differential mechanism includes a ring gear R1 as the first rotating element, the sun gear S1 as the second rotating element, and the carrier C1 as the third rotating element. The second differential mechanism includes the sun gear S2 as the first rotating element, a ring gear R2 as the second rotating element, and the carrier C2 as the third rotating element.

FIG. 12B shows alignment charts according to a second modification of the X-coupled type. In the second modification, a carrier C1 of a first differential mechanism and a carrier C2 of a second differential mechanism are connected to each other, a brake which is the engaging device is provided on these rotating elements, and a clutch is provided between a ring gear R1 of the first differential mechanism and a ring gear R2 of the second differential mechanism. In the second modification, the alignment chart of the second differential mechanism of the output system is shorter than the alignment chart of the first differential mechanism. In the second modification, the first differential mechanism includes the ring gear R1 as the first rotating element, a sun gear S1 as the second rotating element, and the carrier C1 as the third rotating element. The second differential mechanism includes a sun gear S2 as the first rotating element, the ring gear R2 as the second rotating element and the carrier C2 as the third rotating element.

FIG. 12C shows alignment charts according to a third modification of the X-coupled type. In the third modification, a carrier C1 of a first differential mechanism and a carrier C2 of a second differential mechanism are connected to each other, a brake which is the engaging device is provided on these rotating elements, and a clutch is provided between a sun gear S1 of the first differential mechanism and a ring gear R2 of the second differential mechanism. In the third modification, the alignment chart of the second differential mechanism of the output system is longer than the alignment chart of the first differential mechanism. In the third modification, the first differential mechanism includes the sun gear S1 as the first rotating element, a ring gear R1 as the second rotating element, and the carrier C1 as the third rotating element. The second differential mechanism includes a sun gear S2 as the first rotating element, the ring gear R2 as the second rotating element and the carrier C2 as the third rotating element.

FIG. 12D shows alignment charts according to a fourth modification of the X-coupled type. In the fourth modification, a carrier C1 of a first differential mechanism and a carrier C2 of a second differential mechanism are connected to each other, a brake which is the engaging device is provided on these rotating elements, and a clutch is provided between a ring gear R1 of the first differential mechanism and a ring gear R2 of the second differential mechanism. In the fourth modification, the alignment chart of the second differential mechanism of the output system is longer than the alignment chart of the first differential mechanism. In the fourth modification, the first differential mechanism includes the ring gear R1 as the first rotating element, a sun gear S1 as the second rotating element, and the carrier C1 as the third rotating element. The second differential mechanism includes a sun gear S2 the first rotating element, the ring gear R2 as the second rotating element and the carrier C2 as the third rotating element.

FIG. 12E shows alignment charts according to a fifth modification of the X-coupled type. In the fifth modification, a carrier C1 of a first differential mechanism and a carrier C2 of a second differential mechanism are connected to each other, a brake which is the engaging device is provided on these rotating elements, and a clutch is provided between a ring gear R1 of the first differential mechanism and a ring gear R2 of the second differential mechanism. In the fifth modification, the alignment chart of the second differential mechanism of the output system is shorter than the alignment chart of the first differential mechanism. In the fifth modification, the first differential mechanism includes a sun gear S1 as the first rotating element, the ring gear R1 as the second rotating element, and the carrier C1 as the third rotating element. The second differential mechanism includes the ring gear R2 as the first rotating element, a sun gear S2 as the second rotating element and the carrier C2 as the third rotating element.

FIG. 12F shows alignment charts according to a sixth modification of the X-coupled type. In the sixth modification, a carrier C1 of a first differential mechanism and a carrier C2 of a second differential mechanism are connected to each other, a brake which is the engaging device is provided on these rotating elements, and a clutch is provided between a ring gear R1 of the first differential mechanism and a sun gear S2 of the second differential mechanism. In the sixth modification, the alignment chart of the second differential mechanism of the output system is shorter than the alignment chart of the first differential mechanism. In the sixth modification, the first differential mechanism includes the ring gear R1 as the first rotating element, a sun gear S1 as the second rotating element, and the carrier C1 as the third rotating element. The second differential mechanism includes a ring gear R2 as the first rotating element, the sun gear S2 as the second rotating element and the carrier C2 as the third rotating element.

FIG. 12G shows alignment charts according to a seventh modification of the X-coupled type. In the seventh modification, a carrier C1 of a first differential mechanism and a carrier C2 of a second differential mechanism are connected to each other, a brake which is the engaging device is provided on these rotating elements, and a clutch is provided between a sun gear S1 of the first differential mechanism and a ring gear R2 of the second differential mechanism. In the seventh modification, the alignment chart of the second differential mechanism of the output system is longer than the alignment chart of the first differential mechanism. In the seventh modification, the first differential mechanism includes a ring gear R1 as the first rotating element, the sun gear S1 as the second rotating element, and the carrier C1 as the third rotating element. The second differential mechanism includes the ring gear R2 as the first rotating element, a sun gear S2 as the second rotating element and the carrier C2 as the third rotating element.

The modifications of the X-coupled type shown in FIGS. 12A to 12G shares similarity with the fourth embodiment in that (1) the alignment charts are superposed on one straight line at the time of the series parallel hybrid mode, and (2) a rotation speed ratio of the second motor generator 5 and the output portion 4 may be varied in a stepless manner at the time of series parallel hybrid mode. Concerning these common points, the same effects as those of the fourth embodiment may be obtained.

The first and second differential mechanisms are constituted as the planetary gear mechanisms, but this is only one example, and it is also possible to carry out the invention by constituting at least one of the first and second differential mechanisms as a planetary roller mechanism having a friction wheel (roller) instead of a gear as the rotating element. It is also possible to carry out the invention by replacing the first motor generator 3 by a power generator, and replacing the second motor generator 5 by a motor.

1. A vehicular drive unit comprising:
an internal combustion engine; a first rotating electrical machine;
an output portion which transmits power to driving wheels of a vehicle;
a second rotating electrical machine;
a first differential mechanism which includes mutually differentially rotatable three rotating elements, the internal combustion engine being connected to a first rotating element which is one of the three rotating elements and the first rotating electrical machine being connected to a second rotating element which is another one of the three rotating elements;
a second differential mechanism which includes mutually differentially rotatable three rotating elements, the output portion being connected to a first rotating element which is one of the three rotating elements and the second rotating electrical machine being connected to a second rotating element which is another one of the three rotating elements;
a connecting member which connects a third rotating element which is a remaining one of the three rotating elements of the first differential mechanism and a third rotating element which is a remaining one of the three rotating elements of the second differential mechanism with each other such that the third rotating elements may integrally rotate; and
an engaging device capable of switching between a fixed state in which the third rotating element of the first differential mechanism and the third rotating element of the second differential mechanism which are connected to each other are locked with respect to a fixing member and a released state in which the locked state is released.

2. The drive unit according to claim 1, wherein the second differential mechanism is constituted such that the rotation speed of the second rotating electrical machine becomes higher than the rotation speed of the output portion when the fixed state is established by the engaging device.

3. The drive unit according to claim 1, further comprising a clutch which is interposed between one of the first rotating element and the second rotating element of the first differential mechanism and one of the first rotating element and the second rotating element of the second differential mechanism, and which may switch between a connected state in which these rotating elements are integrally rotatably connected to each other and a release state in which the connected state is released.

4. The drive unit according to claim 1, wherein the first differential mechanism is constituted as a single pinion planetary gear mechanism including a sun gear, a ring gear and a carrier as the three rotating elements, the second differential mechanism is constituted as a single pinion planetary gear mechanism including a sun gear, a ring gear and a carrier as the three rotating elements, and
one of the following three configurations is established: the third rotating element of the first differential mechanism is the sun gear and the third rotating element of the second differential mechanism is the sun gear; the third rotating element of the first differential mechanism is the sun gear and the third rotating element of the second differential mechanism is the ring gear; and the third rotating element of the first differential mechanism is the ring gear and the third rotating element of the second differential mechanism is the ring gear.

5. The drive unit according to claim 4, wherein the third rotating element of the first differential mechanism is the sun gear and the third rotating element of the second differential mechanism is the sun gear, and
the engaging device is disposed on a side opposite from the internal combustion engine across the first rotating electrical machine, the first differential mechanism, the second differential mechanism, the second rotating electrical machine and the output portion.

6. The drive unit according to claim 4, wherein the third rotating element of the first differential mechanism is the sun gear and the third rotating element of the second differential mechanism is the ring gear.
